(19) United States
(12) Patent Application Publication
(10) Pub. No.: US 2025/0313251 A1
(43) Pub. Date: Oct. 9, 2025

(54) FOLDABLE MULTIFUCTIONAL BABY STROLLER

(71) Applicant: QINGDAO WOTANDI OUTDOOR CO., LTD., QINGDAO (CN)

(72) Inventor: RUNHU LIU, JIAONAN CITY (CN)

(21) Appl. No.: 18/629,888

(22) Filed: Apr. 8, 2024

(51) Int. Cl. B62B 7/06; B62B 9/18

(52) U.S. Cl. CPC B62B 7/06; B62B 9/18; B62B 2205/20; B62B 2301/04; B62B 2301/20

(57) ABSTRACT

A foldable multifunctional baby stroller is provided. A locking mechanism is provided at the joint between an upper front beam, an upper rear beam and an upright column of a side frame to maintain the main frame in an unfolded state. In the locked state, only pulling the switch plate upward and then lifting the locking mechanism upward can realize the switch of the main frame from the unfolded state to the folded state. Pulling the switch plate upward and then pressing the locking mechanism downward can realize the switch of the main frame from the folded state to the unfolded state, and after the unfolded state and folded state are transformed, the locking mechanism will automatically enter the locked state without additional operations.

### FIELD OF THE DISCLOSURE

The present disclosure relates to the technical field of children strollers, and more particularly to a foldable multifunctional baby stroller.

### BACKGROUND OF THE DISCLOSURE

The main frame of the foldable multifunctional baby stroller is a rectangular frame, and the middle position of the main frame can be raised upward relative to the front and rear ends, so that the main frame turns into a folded state, such as the stroller disclosed in U.S. Pat. No. 16,322,153 B2. The storage space of such type of stroller is larger than that of ordinary strollers and can be used as a stroller to carry 1-4 babies out, or as a platform for babies to play. Further, the stroller also takes up less space when folded and is easy to carry and store. In the process of pushing such type of stroller forward, when the front end of the stroller or the front wheel is obstructed, the main frame will be subjected to a reaction force opposite to the thrust, and the reaction force and the thrust jointly act on the main frame, thus causing the main frame to fold abnormally, so there is a defect of poor stability.

In view of the above-mentioned defects in the prior art, the present disclosure provides a foldable multifunctional baby stroller.

### SUMMARY OF THE DISCLOSURE

The object of the present disclosure is to provide a foldable multifunctional baby stroller that can be locked in an unfolded state or a folded state, making the structure of the stroller stable and reliable, and the unfolding and folding operations are simple and can realize automatic locking function.

In order to achieve the above object, the present disclosure provides a foldable multifunctional baby stroller, including a main frame that is foldable and a wheel assembly. The main body frame includes a front frame, a rear frame and a side frame. The side frame includes an upright column, an upper front beam interconnected between the upright column and the front frame, a lower front beam interconnected between the upright column and the front frame, an upper rear beam interconnected between the upright column and the rear frame, a lower rear beam interconnected between the upright column and the rear frame, and a locking mechanism provided corresponding to a joint of the upper front beam, the upper rear beam and the upright column. The locking mechanism includes a base plate, movable pins, and a switch plate, and the base plate is fixedly connected to an upper end of the upright column. A fixing pin is provided on the base plate, and the upper front beam and the upper rear beam are correspondingly and rotatably connected to the fixing pin. A first long hole corresponding to a bottom of the fixing pin is provided on the base plate, a long side of the first long hole extends in an up-down direction, a second long hole corresponding to the first long hole is provided on each of the upper front beam and the upper rear beam. The second long hole has an arc segment, a first straight line segment and a second straight line segment. The first straight line segment is arranged at one end of the arc segment, and when the main body frame is in an unfolded state, the first straight line segment is aligned with the first long hole and the second straight line segment is arranged at another end of the arc segment, and when the main frame is in a folded state, the second straight line segment is aligned with the first long hole. The movable pin is configured to correspondingly pass through the first long hole and the second long hole. The switch plate is correspondingly and fixedly connected to the movable pins, the switch plate is configured to control the movable pin to move upward to switch from the first straight line segment or the second straight line segment of the second long hole to an entrance of the arc segment of the second long hole. A first spring is provided between the switch plate and the base plate, and the first spring is configured to provide an elastic force to push the switch plate downward.

In an embodiment, the base plate includes two fixing pins, the two fixing pins are spaced apart along a front-rear direction, the upper front beam is rotatably connected to one of the two fixing pins, and the upper rear beam is rotatably connected to another one of the two fixing pins.

In an embodiment, in a left-right direction, the upper front beam and the upper rear beam have a first gap therebetween, the locking mechanism includes a partition, and the partition is provided in the first gap to separate the upper front beam and the upper rear beam and configured to guide the upper front beam and the upper rear beam to rotate.

In an embodiment, the base plate includes a left plate body and a right plate body that are arranged oppositely, and an upper plate body interconnected between an upper part of the left plate body and an upper part of the right plate body. Each of the upper front beam, the upper rear beam and the partition is arranged between the left plate body and the right plate body.

In an embodiment, an arc length of the arc segment of the second long hole is L/4, and L is a circumference of a circle taking the fixing pin as a center of the circle and a distance from the fixing pin to an intersection of the arc segment and the first straight line segment of the second long hole as a radius.

In an embodiment, a lower end of the upright column is connected to a connecting plate, the connecting plate includes two synchronizing gears engaging each other, one of the two synchronizing gears is fixedly connected to the lower front beam, and another one of the two synchronizing gears is fixedly connected to the lower rear beam.

In an embodiment, a decorative cover is correspondingly provided on an outside of the connecting plate and an outside the synchronizing gear.

In an embodiment, the locking mechanism includes a decorative cover, a hole is provided on a side of the decorative cover and the switch plate is exposed from the hole.

In an embodiment, each of the upper front beam and the upper rear beam includes a steel plate and a decorative tube sleeved outside the steel plate.

In an embodiment, the wheel assembly includes two steering wheels, the front frame includes a front left vertical frame and a front right vertical frame, one of the two steering wheels is connected to a lower end of the front left vertical frame, and another one of the two steering wheels is connected to a lower end of the front right vertical frame.

In an embodiment, the steering wheel includes a wheel bracket and a first axle head, the first axle head is configured to be connected to the front left vertical frame or the front right vertical frame. An annular groove that is downwardly concave is provided on a top of the wheel bracket, a center line of the annular groove coincides with a center line of the first axle head, a damping piece is movably provided in the annular groove, at least one second spring is provided between the damping piece and a bottom of the annular groove, and a top of the damping piece protrudes from the top of the wheel bracket and is in contact with a bottom surface of the front left vertical frame or a bottom surface of the front right vertical frame.

In an embodiment, the damping piece includes a rigid ring and a flexible ring, the rigid ring and the flexible ring are stacked on each other, the rigid ring is arranged below the flexible ring, the rigid ring includes a connecting foot, the second spring is a coil spring, and the connecting foot extends into the coil spring.

In an embodiment, at least two second springs are provided, and all the second springs are evenly distributed in the annular groove around the first axle head.

In an embodiment, the wheel assembly includes an axle and two rear wheels, a middle part of the axle is fixedly connected to a brake pedal, two ends of the axle are respectively and fixedly connected to two shock-absorbing brackets, a plug-in part is provided on a top of the shock-absorbing bracket, the rear frame is detachably connected to the plug-in part, the rear wheel includes a second axle head, and the second axle head penetrates the shock-absorbing bracket and is fixedly connected to the axle.

In an embodiment, the axle includes an inner axle tube and an outer tube that are sleeved with each other, a center line of the inner axle tube coincides with a center line of the outer tube, and a second gap is provided between the outer tube and the inner axle tube.

In an embodiment, the outer tube and the inner axle tube are aluminum alloy tubes, an outer diameter of the outer tube is 22 mm, an outer diameter of the inner axle tube is 18 mm, a wall thickness of the inner axle tube is 6 mm, and the second gap is 20 dmm.

Compared with the prior art, the present disclosure at least has the following beneficial effects.

Since there is the locking mechanism at the joint between the upper front beam, the upper rear beam and the upright column, the main frame can be maintained in the unfolded state. When the stroller is subjected to a reaction force opposite to the thrust during advancement, the main frame cannot be folded abnormally, so that the foldable multifunctional baby stroller provided by the present disclosure is stable and reliable.

The main frame is locked by the same locking mechanism in both unfolded and folded states.

Moreover, in the locked state, it only needs to pull the switch plate upward and then lift the locking mechanism upward to realize the switch of the main frame from the unfolded state to the folded state. On the contrary, pulling the switch plate upward and then pressing the locking mechanism downward can switch the main frame from the folded state to the unfolded state, and after switching from the unfolded state to the folded state, or from the folded state to the unfolded state, the locking mechanism will automatically enter the locking state without additional operations, so the folding and unfolding operations of the main frame are simple and convenient.

### BRIEF DESCRIPTION OF THE DRAWINGS

FIG. 1 is a first schematic structural diagram of a foldable multifunctional baby stroller according to an embodiment;

FIG. 2 is a second schematic structural diagram of the foldable multifunctional baby stroller according to an embodiment;

FIG. 3 is a first schematic structural diagram of a side frame;

FIG. 4 is a second schematic structural diagram of the side frame;

FIG. 5 is a first schematic structural diagram of a locking mechanism;

FIG. 6 is a second schematic structural diagram of the locking mechanism;

FIG. 7 is a third schematic structural diagram of the locking mechanism;

FIG. 8 is a fourth schematic structural diagram of the locking mechanism;

FIG. 9 is a fifth schematic structural diagram of the locking mechanism;

FIG. 10 shows a first state of the locking mechanism;

FIG. 11 shows a second state of the locking mechanism;

FIG. 12 shows a third state of the locking mechanism;

FIG. 13 shows a fourth state of the locking mechanism;

FIG. 14 is a first schematic structural diagram of a steering wheel;

FIG. 15 is a second schematic structural diagram of the steering wheel;

FIG. 16 is a cross-sectional view taken along A-A in FIG. 15;

FIG. 17 is a schematic diagram of the components of the axle, the shock-absorbing bracket and the brake pedal;

FIG. 18 is a schematic diagram of an axle;

FIG. 19 is a cross-sectional view taken along B-B in FIG. 18; and

FIG. 20 is a schematic diagram of the folded state of the stroller.

### REFERENCE NUMERAL

100, main frame; 110, front frame; 111, front horizontal frame; 112, front right vertical frame; 113, front left vertical frame; 120, side frame; 121, upright front beam; 1210, second long hole; 1211, second straight line segment; 1212, arc segment; 1213, first straight line segment; 122, lower front beam; 123, pillar; 1231, synchronizing gear; 1232, connecting plate; 124, lower rear beam; 125, locking mechanism; 1251, movable pin; 1252, first long hole; 1253, base plate; 12531, left plate body; 12532, right plate body; 12533, upper plate body; 1254, fixing pin; 1255, first spring; 1256, guide part; 1257, switch plate; 1258, partition; 1259, decorative cover; 126, upper rear beam; 130, rear frame; 131, rear horizontal frame; 132, rear left vertical frame; 133, rear right vertical frame; 200, wheel component; 210, steering wheel; 211, wheel bracket; 212, second spring; 213, damping piece; 2131, rigid ring; 2132, flexible ring; 2133, connecting foot; 214, first axle head; 215, annular groove; 220, rear wheel; 221, second axle head; 230, axle; 231, outer tube; 232, inner axle tube; 233, second gap; 240, shock-absorbing bracket; 241, plug-in part; 250, brake pedal; and Y1, circle.

### DETAILED DESCRIPTION OF THE EXEMPLARY EMBODIMENTS

The present disclosure will be further described in detail below in conjunction with the accompanying drawings.

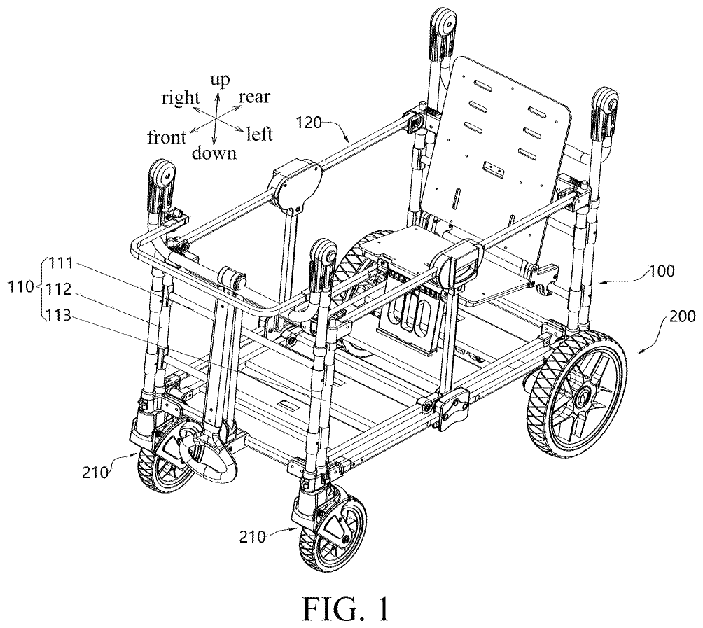

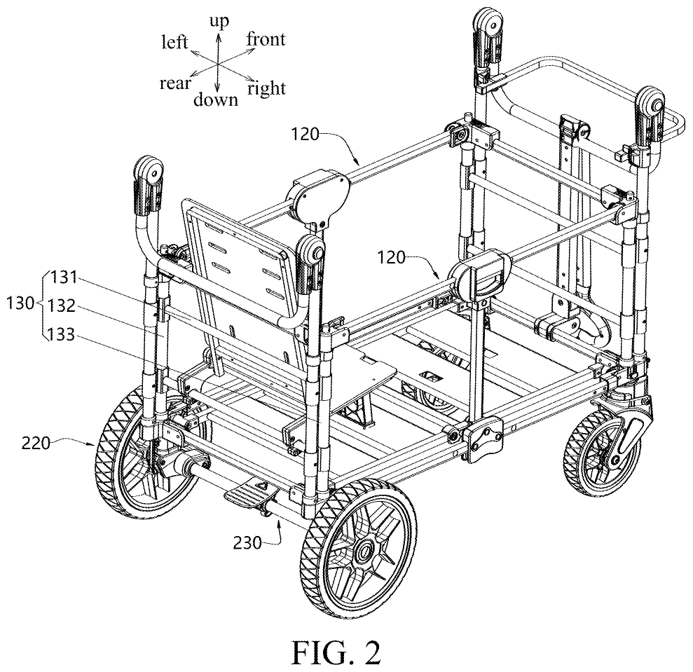

Referring to FIGS. 1 and 2, a foldable multifunctional baby stroller provided by the present disclosure includes a foldable main frame 100 and a wheel assembly 200.

The main frame 100 includes a front frame 110, a rear frame 130 and two side frames 120. The main frame 100 is generally a rectangular parallelepiped structure.

The front frame 110 includes a front right vertical frame 112, a front left vertical frame 113 and a plurality of front horizontal frames 111. A steering wheel 210 is installed on each of a lower end of the front right vertical frame 112 and a lower end of the front left vertical frame 113. The front frame 110 is further connected with a front armrest and a pull rod, and a driving force to move the stroller can be applied through the front armrest or the pull rod.

The rear frame 130 includes a rear left vertical frame 132, a rear right vertical frame 133 and a plurality of rear horizontal frames 131. A lower end of the rear left vertical frame 132 and A lower end of the rear right vertical frame 133 are correspondingly connected to an axle 230, and rear wheels 220 are correspondingly installed on the axle 230. The rear frame 130 is further connected with a rear armrest, through which the driving force can be applied to move the stroller.

One of the two side frames 120 is arranged on a left side, and another of the two side frames 120 is arranged on a right side. The two side frames 120 have the same structure. The following takes the left side frame 120 as an example to describe the structure of the side frame 120.

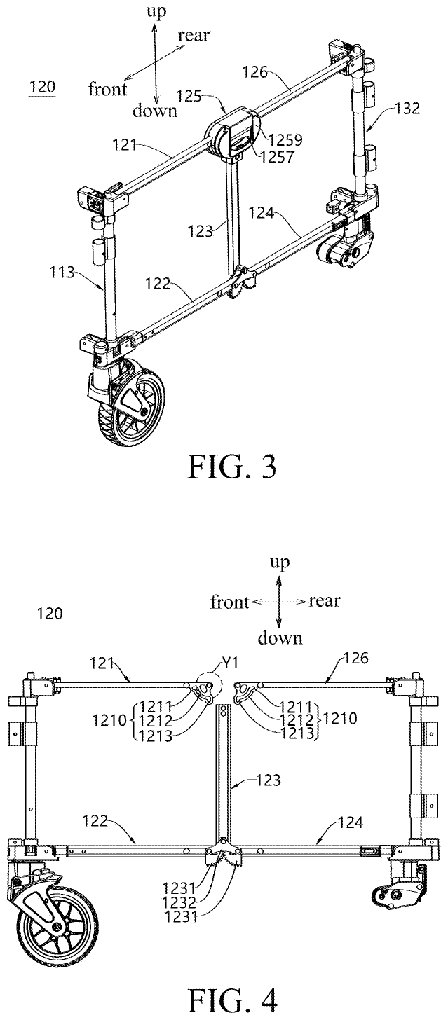

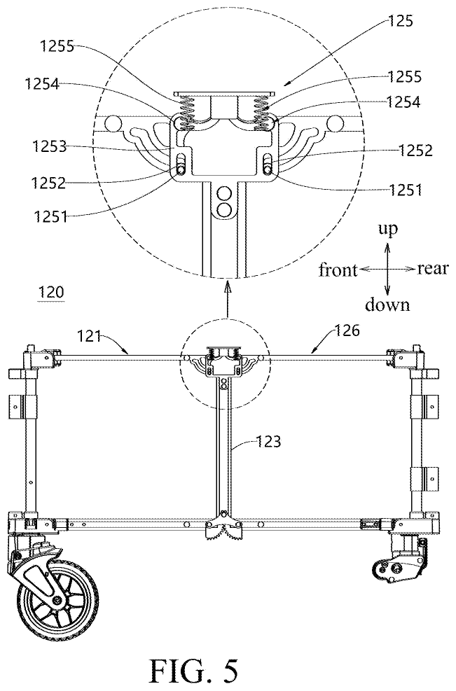

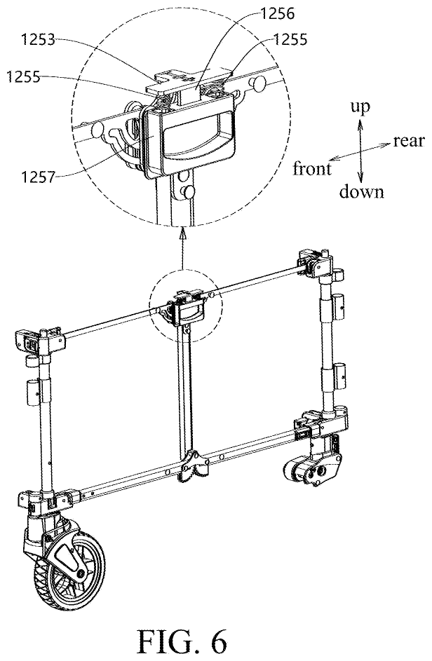

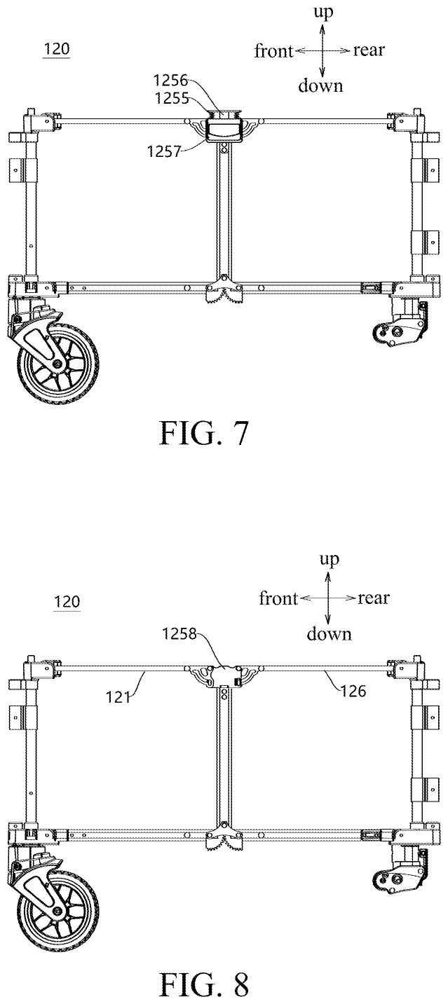

Referring to FIGS. 3 to 13, the side frame 120 includes an upright column 123, an upper front beam 121, a lower front beam 122, an upper rear beam 126, a lower rear beam 124, and a locking mechanism 125. The upright column 123, the front left vertical frame 113, and the rear left vertical frame 132 are substantially parallel to each other. Each of the upper front beam 121 and the lower front beam 122 is connected between the upright column 123 and the front left vertical frame 113, and each of the upper rear beam 126 and the lower rear beam 124 is connected between the upright column 123 and the rear left vertical frame 132. The connections here are all rotatable connections to realize a folding of the side frame 120. Referring to FIG. 3, in a case upward thrust is applied to a position of the upright column 123, the side frame 120 will deform and switch from an unfolded state to a folded state. After the two side frames 120 are folded, the main frame 100 turns into the folded state. The folded state is as shown in FIG. 20. In the folded state, when downward pressure is applied to the position of the upright column 123, the side frame 120 will deform and switch from the folded state to the unfolded state. After the two side frames 120 are unfolded, the main frame 100 turns into the unfolded state. The unfolded state is as shown in FIG. 1 and FIG. 2.

The locking mechanism 125 is provided at the joint between the upper front beam 121, the upper rear beam 126 and the upright column 123. The locking mechanism 125 is configured to maintain the unfolded state and the folded state.

The locking mechanism 125 includes a base plate 1253, a movable pin 1251 and a switch plate 1257.

The base plate 1253 is fixedly connected to an upper end of the upright column 123. The base plate 1253 is provided with two fixing pins 1254. A rear end of the upper front beam 121 is rotatably connected to one of the two fixing pins 1254 on the base plate 1253, and a front end of the upper rear beam 126 is rotatably connected to another of the two fixing pins 1254 on the base plate 1253, thereby realizing the rotatable connection between the upper front beam 121 and the upright column 123, and the rotatable connection between the upper rear beam 126 and the upright column 123.

A first long hole 1252 is correspondingly provided on parts of the base plate 1253 corresponding to a bottom of each of the two fixing pins 1254, and a long side of the first long hole 1252 extends in a up-down direction. The upper front beam 121 is provided with a second long hole 1210 corresponding to the first long hole 1252, and the upper rear beam 126 is also provided the second long hole 1210 corresponding to the first long hole 1252.

The second long hole 1210 has an arc segment 1212, a first straight line segment 1213 and a second straight line segment 1211.

The first straight line segment 1213 is arranged at one end of the arc segment 1212, and when the main frame 100 is in the unfolded state, the first straight line segment 1213 is aligned with the first long hole 1252.

The second straight line segment 1211 is arranged at another end of the arc segment 1212, and when the main frame 100 is in the folded state, the second straight line segment 1211 is aligned with the first long hole 1252.

The movable pin 1251 correspondingly passes through the first long hole 1252 and the second long hole 1210.

The switch plate 1257 is fixedly connected to the movable pins 1251, and the switch plate 1257 is configured to control the movable pin 1251 to move upward to switch from the first straight line segment 1213 of the second long hole 1210 to an entrance of the arc segment 1212 of the second long hole 1210, or to switch from the second straight line segment 1211 of the second long hole 1210 to the entrance of the arc segment 1212 of the second long hole 1210.

A first spring 1255 is provided between the switch plate 1257 and the base plate 1253. The first spring 1255 is configured to provide an elastic force to reset the switch plate 1257 and the movable pin 1251 downward.

A guide part 1256 extending in the up-down direction is further provided on the base plate 1253. Through a sliding cooperation of the switch plate 1257 and the guide part 1256, the guide part 1256 is configured to guide the switch plate 1257 to move upward or downward.

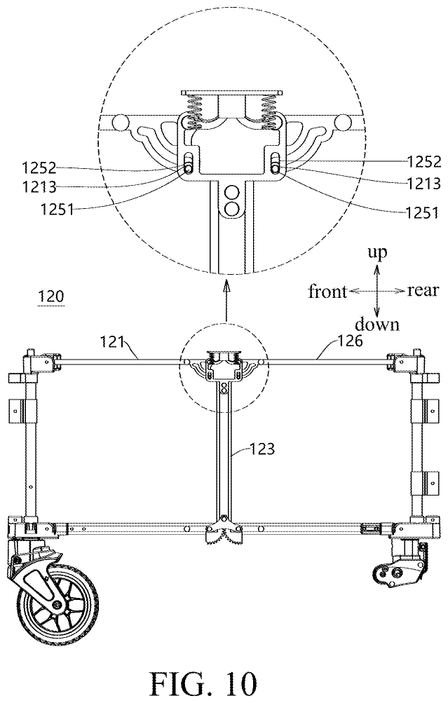

The working principle of the locking mechanism 125 will be described below with reference to FIGS. 10 to 13.

In the present embodiment, the folding of the main frame 100 is achieved by folding the side frame 120. Therefore, the state of the main frame 100 corresponds to the state of the side frame 120, that is, when the side frame 120 is in the unfolded state, the main frame is also in the unfolded state, and when the side frame is in the folded state, the main frame is also in the folded state.

As shown in FIG. 10, the side frame 120 is in the unfolded state. As shown in FIG. 10, in the unfolded state, the first straight line segment 1213 of the second long hole 1210 is aligned with the first long hole 1252. Under the elastic force of the first spring 1255, the movable pin 1251 is correspondingly arranged at the first straight line segment 1213 of the second long hole and the lower end of the first long hole 1252. At this time, the locking mechanism 125 is in a locked state, and the movable pin 1251 cooperates with the first straight line segment 1213 of the second long hole 1210 to provide a limiting function, so that neither the upper front beam 121 nor the upper rear beam 126 can rotate relative to the upright column 123, thereby maintaining the side frame 120 in the unfolded state.

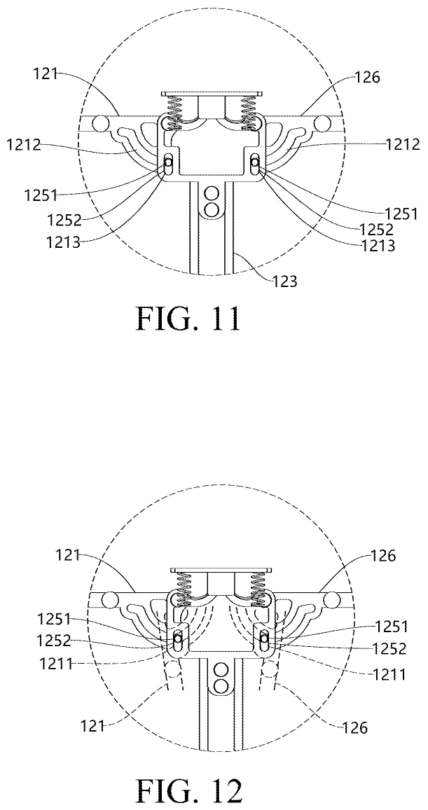

As shown in FIG. 11, in the unfolded state, in order to unlock, the switch plate 1257 is pulled upward against the elastic force of the first spring 1255, so that the switch plate 1257 drives the movable pin 1251 to move upward to switch the movable pin 1251 from the first straight line segment 1213 of the second long hole 1210 to the entrance of the arc segment 1212 of the second long hole 1210. At this time, the locking mechanism 125 turns into an unlocked state, and both the upper front beam 121 and the upper rear beam 126 can rotate relative to the upright column 123 around the fixing pin 1254.

In the unlocked state as shown in FIG. 11, when an upward lifting force is applied to a position of the locking mechanism 125, the lifting force causes both the upper front beam 121 and the upper rear beam 126 to rotate around the fixing pin 1254, and the arc segment 1212 of the second long hole 1210 slides along the movable pin 1251. When a end part of the arc segment 1212 is in contact with the movable pin 1251, the rotation of the upper front beam 121 and the upper rear beam 126 is terminated, and the side frame 120 turns into the folded state. At this time, positions of the upper front beam 121 and the upper rear beam 126 are shown as dotted lines in FIG. 12, and the second straight line segment 1211 is aligned with the first long hole 1252.

After being turned into the state as shown in FIG. 12, the elastic force of the first spring 1255 causes the movable pin 1251 to move downward and correspondingly return to the lower end of the first long hole 1252 and the second straight line segment 1211 of the second long hole 1210, as shown in FIG. 13. At this time, the locking mechanism 125 turns into the locking state, and the movable pin 1251 cooperates with the second straight line segment 1211 of the second long hole 1210 to provide the limiting function, so that neither the upper front beam 121 nor the upper rear beam 126 can rotate relative to the upright column 123, thereby maintaining the side frames 120 in the folded state.

In FIG. 13 the state of the upper front beam 121 and the upper rear beam 126 when they are locked in the folded state, as well as the relation of the relative positions of the movable pin 1251, the first long hole 1252, and the second straight line segment 1211 of the second long hole 1210 are shown as dotted lines.

In the folded state as shown in FIG. 13, in order to unlock, the switch plate 1257 is pulled upward against the elastic force of the first spring 1255, so that the switch plate 1257 drives the movable pin 1251 to move upward to switch the movable pin 1251 from the second straight line segment 1211 of the second long hole 1210 to the entrance of the arc segment 1212 of the second long hole 1210, that is, the movable pin 1251 is switched from the position shown in FIG. 13 to the position shown in FIG. 12. At this time, the locking mechanism 125 turns into the unlocked state, and both the upper front beam 121 and the upper rear beam 126 can rotate relative to the upright column 123 around the fixing pin 1254.

After being turned into the unlocked state, the downward pressure is applied to the position of the locking mechanism 125. Such pressure causes the upper front beam 121 and the upper rear beam 126 to rotate relative to the upright column 123 around the fixing pin 1254 and the arc segment 1212 of the second long hole 1210 slides along the movable pin 1251. When the end part of the arc segment 1212 is in contact with the movable pin 1251, the rotation of the upper front beam 121 and the upper rear beam 126 is terminated, and the side frame 120 turns into the unfolded state. At this time, the positions of the upper front beam 121 and the upper rear beam 126 are shown as a solid line in FIG. 12 or as shown in FIG. 11, and the first straight line segment 1213 is aligned with the first long hole 1252.

After being turned into the state as shown in FIG. 11, the elastic force of the first spring 1255 causes the movable pin 1251 to move downward and correspondingly return to the lower end of the first long hole 1252 and the first straight line segment 1213 of the second long hole 1210, as shown in FIG. 10. At this time, the locking mechanism 125 turns into the locking state, and the movable pin 1251 cooperates with the first straight line segment 1213 of the second long hole 1210 to provide the limiting function, so that neither the upper front beam 121 nor the upper rear beam 126 can rotate relative to the upright column 123, thereby maintaining the side frames 120 in the unfolded state.

In the above embodiment, since the locking mechanism 125 is provided at the joint between the upper front beam 121, the upper rear beam 126 and the upright column 123, the main body frame 100 can be maintained in the unfolded state. When the stroller is subjected to an opposite thrust force during pushing, the locking mechanism 125 prevents the upper front beam 121 and the upper rear beam 126 from rotating relative to the upright column 123, so that the main frame 100 will not be abnormally folded, and the stroller is stable and reliable.

The main frame 100 of the stroller is locked by the same locking mechanism 125 in both the unfolded state and the folded state.

Moreover, in the locked state, it only needs to pull the switch plate 1257 upward and then lift the locking mechanism 125 upward to realize the switch of the main frame 100 from the unfolded state to the folded state. On the contrary, pulling the switch plate 1257 upward and then pressing the locking mechanism 125 downward can realize the switch of the main frame 100 from the folded state to the unfolded state, and after switching from the unfolded state to the folded state, or from the folded state to the unfolded state, no additional operation is required, and the locking mechanism 125 will automatically turn into the locking state under the elastic force of the first spring 1255. Therefore, the folding and unfolding operations of the main frame 100 are simple and convenient.

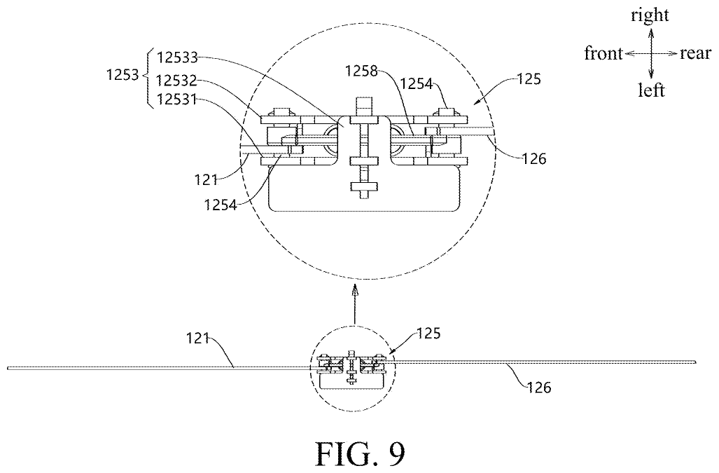

Referring to FIGS. 8 and 9, in a left-right direction, a first gap is provided between the upper front beam 121 and the upper rear beam 126. The locking mechanism 125 also includes a partition 1258. The partition 1258 is disposed in the first gap. The partition 1258 is configured to separate the upper front beam 121 and the upper rear beam 126, and to guide the rotation of the upper front beam 121 and the upper rear beam 126. In the present embodiment, the partition 1258 is provided to prevent the upper front beam 121 and the upper rear beam 126 from interfering, thereby preventing unsmooth phenomena during the unfolding or folding process.

Referring to FIG. 9, the base plate 1253 includes a left plate body 12531 and a right plate body 12532 that are arranged oppositely, and an upper plate body 12533 interconnected between an upper part of the left plate body 12531 and an upper part of the right plate body 12532. Each of the upper front beam 121, the upper rear beam 126, and the partition 1258 is arranged between the left plate body 12531 and the right plate body 12532. In the present embodiment, the above-mentioned structure of the base plate 1253 enables the base plate 1253 to further limit the upper front beam 121 and the upper rear beam 126 in the left-right direction to avoid displacement in the left-right direction.

Referring to FIG. 4, an arc length of the arc segment 1212 of the second long hole 1210 is L/4, where L is a circumference of a circle Y1, the circle Y1 takes the fixing pin 1254 as a center, and a distance from the fixing pin 1254 to an intersection of the arc segment 1212 of the second long hole 1210 and the first straight line segment 1213 as a radius. In the present embodiment, a folding angle of the upper front beam 121 and the upright column 123, and a folding angle between the upper rear beam 126 and the upright column 123 are approximately 90 degrees. The folded state of the stroller is shown in FIG. 20. It can be seen that compared with the unfolded state, a front-rear dimension of the stroller is greatly reduced after folding, which will facilitate the handling and storage of the stroller.

Referring to FIG. 4, a lower end of the upright column 123 is connected to a connecting plate 1232. The connecting plate 1232 includes two synchronizing gears 1231 engaging each other. One of the two synchronizing gears 1231 is fixedly connected to the lower front beam 122, and another of the two synchronizing gears 1231 is fixedly connected with the lower rear beam 124. In the present embodiment, the two synchronizing gears 1231 are configured to produce a certain damping effect during the above-mentioned unfolding or folding process to avoid abrupt unfolding or folding operations.

Referring to FIGS. 1 and 4, a decorative cover is provided outside the connecting plate 1232 and the synchronizing gears 1231, which can play a role in decoration and protection.

Referring to FIG. 3, the locking mechanism 125 includes a decorative cover 1259. There is a hole on a side of the decorative cover 1259, and the switch plate 1257 is exposed from the hole. An outer surface of the decorative cover 1259 is smooth and has no edges and corners, so it is not harmful to the baby during use. The decorative cover 1259 can play the role of decoration and protection.

Each of the upper front beam 121 and the upper rear beam 126 includes a steel plate and a decorative tube, and the decorative tube is sleeved outside the steel plate. The decorative tube can be made of a plastic material, for example. Compared with plastic, the steel plates have better strength. The upper front beam 121 and the upper rear beam 126, which are constructed by a combination of steel plates and decorative tubes, have both load-bearing and decorative effects.

In the above embodiment, the base plate 1253 includes two fixing pins 1254. The two fixing pins 1254 are spaced apart along a front-rear direction. The upper front beam 121 is rotatably connected to one of the two fixing pins 1254. The upper rear beam 126 is rotatably connected to another of the two fixing pins 1254. The two fixing pins 1254 respectively correspond to the movable pin 1251 and the first long hole 1252.

As another embodiment, the number of fixing pins 1254 on the base plate 1253 is one. Correspondingly, the number of the first long hole 1252 and the number of the movable pin 1251 are both one. The rear end of the upper front beam 121 and the front end of the upper rear beam 126 are correspondingly and rotatably connected to the fixing pin 1254. The second long hole 1210 of the upper front beam 121 and the second long hole 1210 of the upper rear beam 126 correspondingly cooperate with the movable pin 1251.

Referring to FIGS. 1 and 2, in the above embodiment, the upper front beam 121 and the upper rear beam 126 are functioned as guardrails to prevent the baby from accidentally falling out of the stroller when standing.

Referring to FIG. 1, the wheel assembly 200 includes two steering wheels 210, one of the two steering wheels 210 is connected to the lower end of the front left vertical frame 113, and another of the two steering wheels 210 is connected to the lower end of the front right vertical frame 112. Compared with adopting one steering wheel 210, two steering wheels 210 are used in the present embodiment, and the two steering wheels 210 are respectively connected to the front left vertical frame 113 and the front right vertical frame 112, so as to achieve a better load bearing capacity and stability.

In the prior art, the steering wheel 210 is connected to the stroller through an axle head. When the stroller is pushed on a smooth floor (such as the surface of glazed tiles), since a friction between the steering wheel 210 and the ground is small, the steering wheel 210 will swing around its axle, and a “clicking” noise will be generated. In view of this shortcoming, the present embodiment further makes the following improvements.

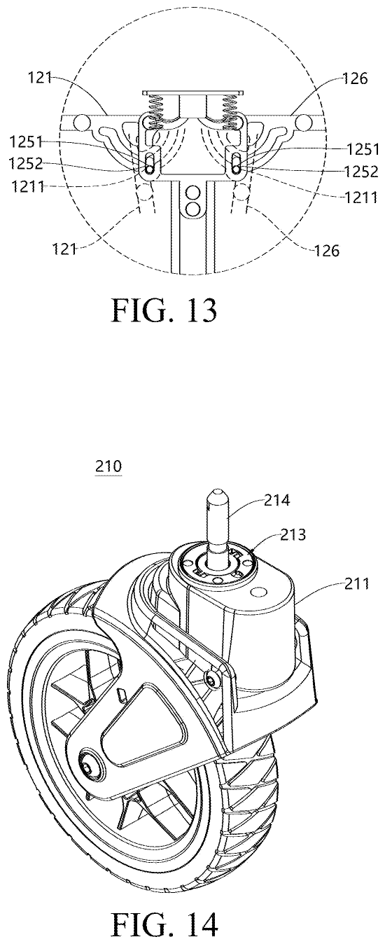

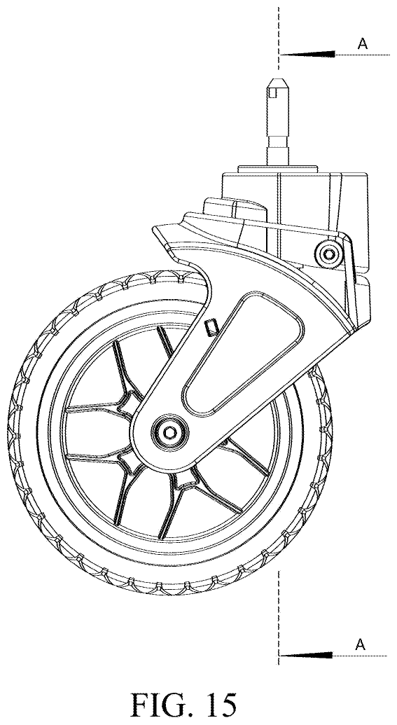

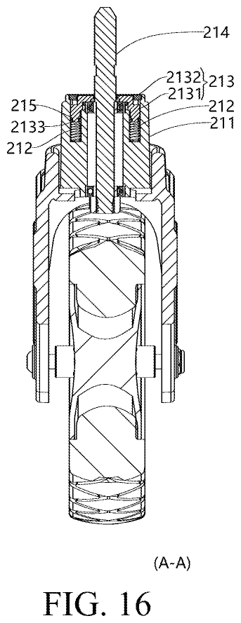

Referring to FIGS. 14 to 16 and FIG. 1, the steering wheel 210 includes a wheel bracket 211 and a first axle head 214. The first axle head 214 is configured to be connected to the front left vertical frame 113 or the front right vertical frame 112. A top of the wheel bracket 211 is provided with an annular groove 215 that is downwardly concave. A center line of the annular groove 215 coincides with a center line of the first axle head 214. The annular groove 215 is movable provided with a damping piece 213. A second spring 212 is provided between the damping piece 213 and the bottom of the annular groove 215. A top of the damping piece 213 protrudes from the top of the wheel bracket 211 and is in fitting contact with a bottom surface of the front left vertical frame 113 or a bottom surface of the front right vertical frame 112. The second spring 212 provides an elastic force to push the damping piece 213 upward. In the present embodiment, the second spring 212 and the damping piece 213 are combined to increase a friction between the steering wheel 210 and the front left vertical frame 113 and the front right vertical frame 112 of the front frame 100, so that when the stroller is pushed on a smooth floor (such as the surface of glazed tiles), the front frame 100 generates resistance through the damping piece 213 to prevent the steering wheel 210 from swinging around the first axle head 214, thereby preventing the steering wheel 210 from swinging, and preventing the steering wheel 210 from swinging and producing the “clicking” noise. When turning is required, the stroller can be turned by simply pushing an external force to overcome the resistance.

The damping piece 213 adopts an assembly. The damping piece 213 includes a rigid ring 2131 and a flexible ring 2132. The rigid ring 2131 and the flexible ring 2132 are stacked on each other. The rigid ring 2131 is arranged below and includes a connecting foot 2133. The second spring 212 is a coil spring, and the connecting pin 2133 of the rigid ring 2131 extends into the coil spring. In the present embodiment, the damping piece 213 is the assembly. When the damping piece 213 is worn, only the flexible ring 2132 in the damping piece 213 needs to be replaced. For example, the rigid ring 2131 is made of steel or hard plastic, and the flexible ring 2132 is made of rubber or silicone.

In the present embodiment, the number of the second springs 212 is two, and the two second springs 212 are evenly distributed in the annular groove 215 around the first axle head 214. The number of the second spring 212 can also be one. When one second spring 212 is used, the second spring 212 surrounds the first axle head 214. The number of the second springs 212 can also be more than two. When more than two second springs 212 are used, all the second springs 212 will be evenly distributed in the annular groove 215 around the first axle head 214.

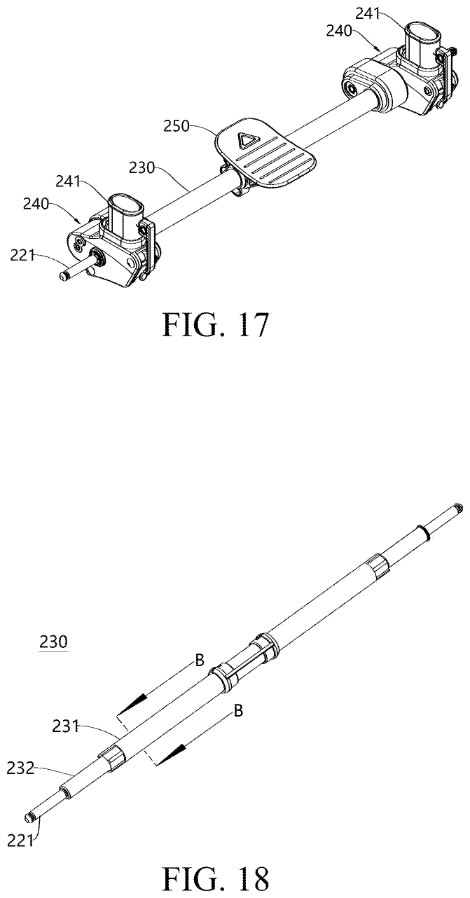

Referring to FIGS. 2 and 17, the wheel assembly 200 includes the axle 230 and two rear wheels 220. A middle part of the axle 230 is fixedly connected to a brake pedal 250, and both ends of the axle 230 are respectively and fixedly connected to two shock-absorbing brackets 240. A top of the shock-absorbing bracket 240 is provided with a plug-in part 241. The rear frame 130 is detachably connected to the plug-in part 241 of the shock-absorbing bracket 240. The rear wheel 220 includes a second axle head 221, and the second axle head 221 penetrates the shock-absorbing bracket 240 and is fixedly connected to the axle 230. In the present embodiment, the axle 230 is detachably connected to the rear frame 130, making it convenient to remove the axle 230 for maintenance.

When the rear wheel 220 and the axle 230 of the above structure bear a large load, the middle part of the axle 230 will bend downward and deform. An upper edge of the rear wheel 220 will be inclined toward a center of the axle 230, and an inclination direction of a lower edge of the wheel is opposite to an inclination direction of an upper edge of the wheel. The left and right rear wheels 220 are in an approximately figure-eight shape. In this way, the wear of the connecting portion of the rear wheel 220 and the second axle head 221 and the wear of the connecting portion of the second axle head 221 and the axle 230 will increase. In view of this shortcoming, the present embodiment further makes the following improvements.

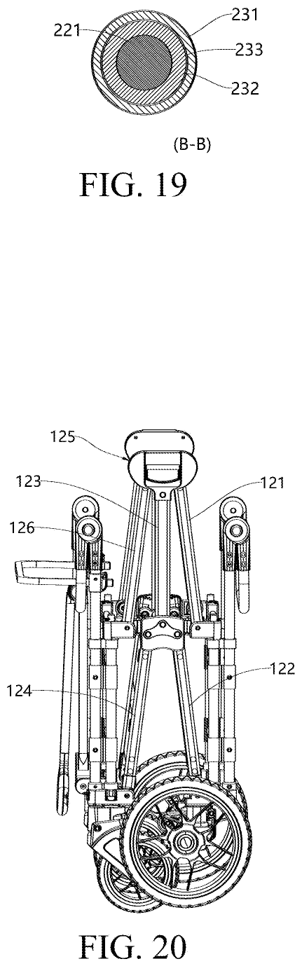

Referring to FIGS. 18 and 19, in the present embodiment, the axle 230 includes an inner axle tube 232 and an outer tube 231 that are sleeved with each other. A center line of the inner axle tube 232 coincides with a center line of the outer tube 231, and a second gap 233 is provided between the outer tube 231 and the inner axle tubes 232.

The second axle head 221 is fixedly connected to the inner axle tube 232. When the axle 230 bears the large load, a middle part of the inner axle tube 232 deforms downward and will touch the outer tube 231, and receive a reaction force from the outer tube 231. This reaction force can reduce the deformation of the axle 230 and reduce the inclination of the rear wheel 220. To such an extent, the wear of the connecting portion of the rear wheel 220 and the second axle head 221 and the wear of the connecting portion of the second axle head 221 and the axle 230 can be reduced.

In one embodiment, the outer tube 231 and the inner axle tube 232 are aluminum alloy tubes. The outer tube 231 has an outer diameter of 22 mm, the inner axle tube 232 has an outer diameter of 18 mm, the inner axle tube 232 has a wall thickness of 6 mm, and the second gap 233 between the outer tube 231 and the inner axle tube 232 is 20 dmm.

The above is only used to illustrate the technical solution of the present disclosure and not to limit it. Other modifications or equivalent substitutions made by those of ordinary skill in the art to the technical solution of the present disclosure can be made. As long as they do not deviate from the spirit and scope of the technical solutions of the present disclosure, they should be covered by the claims of the present disclosure.

What is claimed is:

1. A foldable multifunctional baby stroller, comprising:
a main frame (100) that is foldable and a wheel assembly (200);
wherein the main body frame (100) includes a front frame (110), a rear frame (130) and a side frame (120);
wherein the side frame (120) includes an upright column (123), an upper front beam (121) interconnected between the upright column (123) and the front frame (110), a lower front beam (122) interconnected between the upright column (123) and the front frame (110), an upper rear beam (126) interconnected between the upright column (123) and the rear frame (130), a lower rear beam (124) interconnected between the upright column (123) and the rear frame (130), and a locking mechanism (125) provided corresponding to a joint of the upper front beam (121), the upper rear beam (126) and the upright column (123);
wherein the locking mechanism (125) includes a base plate (1253), movable pins (1251), and a switch plate (1257), and the base plate (1253) is fixedly connected to an upper end of the upright column (123);
wherein a fixing pin (1254) is provided on the base plate (1253), and the upper front beam (121) and the upper rear beam (126) are correspondingly and rotatably connected to the fixing pin (1254);
wherein a first long hole (1252) corresponding to a bottom of the fixing pin (1254) is provided on the base plate (1253), a long side of the first long hole (1252) extends in a up-down direction, a second long hole (1210) corresponding to the first long hole (1252) is provided on each of the upper front beam (121) and the upper rear beam (126), the second long hole (1210) has an arc segment (1212), a first straight line segment (1213), and a second straight line segment (1211), the first straight line segment (1213) is arranged at one end of the arc segment (1212), and when the main body frame (100) is in an unfolded state, the first straight line segment (1213) is aligned with the first long hole (1252); wherein the second straight line segment (1211) is arranged at another end of the arc segment (1212), and when the main frame (100) is in a folded state, the second straight line segment (1211) is aligned with the first long hole (1252);
wherein the movable pin (1251) is configured to correspondingly pass through the first long hole (1252) and the second long hole (1210);
wherein the switch plate (1257) is correspondingly and fixedly connected to the movable pins (1251), the switch plate (1257) is configured to control the movable pin (1251) to move upward to switch from the first straight line segment (1213) or the second straight line segment (1211) of the second long hole (1210) to an entrance of the arc segment (1212) of the second long hole (1210); and
wherein a first spring (1255) is provided between the switch plate (1257) and the base plate (1253), and the first spring (1255) is configured to provide an elastic force to push the switch plate (1257) downward.

2. The foldable multifunctional baby stroller according to claim 1, wherein the base plate (1253) includes two fixing pins (1254), the two fixing pins (1254) are spaced apart along a front-rear direction, the upper front beam (121) is rotatably connected to one of the two fixing pins (1254), and the upper rear beam (126) is rotatably connected to another one of the two fixing pins (1254).

3. The foldable multifunctional baby stroller according to claim 1, wherein in a left-right direction, the upper front beam (121) and the upper rear beam (126) have a first gap therebetween, the locking mechanism (125) includes a partition (1258), and the partition (1258) is provided in the first gap to separate the upper front beam (121) and the upper rear beam (126) and configured to guide the upper front beam (121) and the upper rear beam (126) to rotate.

4. The foldable multifunctional baby stroller according to claim 3, wherein the base plate (1253) includes a left plate body (12531) and a right plate body (12532) that are arranged oppositely, and an upper plate body (12533) interconnected between an upper part of the left plate body (12531) and an upper part of the right plate body (12532), and each of the upper front beam (121), the upper rear beam (126) and the partition (1258) is arranged between the left plate body (12531) and the right plate body (12532).

5. The foldable multifunctional baby stroller according to claim 1, wherein an arc length of the arc segment (1212) of the second long hole (1210) is L/4, and L is a circumference of a circle (Y) taking the fixing pin (1254) as a center of the circle and a distance from the fixing pin (1254) to an intersection of the arc segment (1212) and the first straight line segment (1213) of the second long hole (1210) as a radius.

6. The foldable multifunctional baby stroller according to claim 1, wherein a lower end of the upright column (123) is connected to a connecting plate (1232), the connecting plate (1232) includes two synchronizing gears (1231) engaging each other, one of the two synchronizing gears (1231) is fixedly connected to the lower front beam (122), and another one of the two synchronizing gears (1231) is fixedly connected to the lower rear beam (124).

7. The foldable multifunctional baby stroller according to claim 6, wherein a decorative cover is correspondingly provided on an outside of the connecting plate (1232) and an outside the synchronizing gear (1231).

8. The foldable multifunctional baby stroller according to claim 1, wherein the locking mechanism (125) includes a decorative cover (1259), a hole is provided on a side of the decorative cover (1259) and the switch plate (1257) is exposed from the hole.

9. The foldable multifunctional baby stroller according to claim 1, wherein each of the upper front beam (121) and the upper rear beam (126) includes a steel plate and a decorative tube sleeved outside the steel plate.

10. The foldable multifunctional baby stroller according to claim 1, wherein the wheel assembly (200) includes two steering wheels (210), the front frame (110) includes a front left vertical frame (113) and a front right vertical frame (112), one of the two steering wheels (210) is connected to a lower end of the front left vertical frame (113), and another one of the two steering wheels (210) is connected to a lower end of the front right vertical frame (112).

11. The foldable multifunctional baby stroller according to claim 10, wherein the steering wheel (210) includes a wheel bracket (211) and a first axle head (214), the first axle head (214) is configured to be connected to the front left vertical frame (113) or the front right vertical frame (112); wherein an annular groove (215) that is downwardly concave is provided on a top of the wheel bracket (211), a center line of the annular groove (215) coincides with a center line of the first axle head (214), a damping piece (213) is movably provided in the annular groove (215), at least one second spring (212) is provided between the damping piece (213) and a bottom of the annular groove (215), and a top of the damping piece (213) protrudes from the top of the wheel bracket (211) and is in contact with a bottom surface of the front left vertical frame (113) or a bottom surface of the front right vertical frame (112).

12. The foldable multifunctional baby stroller according to claim 11, wherein the damping piece (213) includes a rigid ring (2131) and a flexible ring (2132), the rigid ring (2131) and the flexible ring (2132) are stacked on each other, the rigid ring (2131) is arranged below the flexible ring (2132), the rigid ring (2131) includes a connecting foot (2133), the second spring (212) is a coil spring, and the connecting foot (2133) extends into the coil spring.

13. The foldable multifunctional baby stroller according to claim 11, wherein at least two second springs (212) are provided, and all the second springs (212) are evenly distributed in the annular groove (215) around the first axle head (214).

14. The foldable multifunctional baby stroller according to claim 1, wherein the wheel assembly (200) includes an axle (230) and two rear wheels (220), a middle part of the axle (230) is fixedly connected to a brake pedal (250), two ends of the axle (230) are respectively and fixedly connected to two shock-absorbing brackets (240), a plug-in part (241) is provided on a top of the shock-absorbing bracket (240), the rear frame (130) is detachably connected to the plug-in part (241), the rear wheel (220) includes a second axle head (221), and the second axle head (221) penetrates the shock-absorbing bracket (240) and is fixedly connected to the axle (230).

15. The foldable multifunctional baby stroller according to claim 14, wherein the axle (230) includes an inner axle tube (232) and an outer tube (231) that are sleeved with each other, a center line of the inner axle tube (232) coincides with a center line of the outer tube (231), and a second gap (233) is provided between the outer tube (231) and the inner axle tube (232).

16. The foldable multifunctional baby stroller according to claim 15, wherein the outer tube (231) and the inner axle tube (232) are aluminum alloy tubes, an outer diameter of the outer tube (231) is 22 mm, an outer diameter of the inner axle tube (232) is 18 mm, a wall thickness of the inner axle tube (232) is 6 mm, and the second gap (234) is 20 dmm.
